(19) United States
(12) Patent Application Publication
(10) Pub. No.: US 2010/0241504 A1
(43) Pub. Date: Sep. 23, 2010

(54) Method of Rewarding On Time Bill Payment

(76) Inventor: Steven Leslie Bolt, Fallbrook, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/729,120

(22) Filed: Mar. 22, 2010

Related U.S. Application Data
(60) Provisional application No. 61/162,104, filed on Mar. 20, 2009.

(51) Int. Cl. G06Q 30/00; G06Q 20/00

(52) U.S. Cl. 705/14.33; 705/14.36

(57) ABSTRACT

A rewards system for bill paying users which provides rewards for paying their bills on time or early to product vendors and service providers. The system tracks payments of subscribing users to subscribing vendors and service providers and issues rewards to users paying on time or a designated amount of time before the due date of an on time payment.

This application claims priority to U.S. Provisional Patent No. 61/162,104 filed Mar. 20, 2009 which is incorporated herein in its entirety by reference.

### BACKGROUND OF THE INVENTION

1. Field of the Invention

The invention herein relates generally to consumer reward programs adapted to induce consumer behavior and loyalty. More particularly, it relates to a method enabling a program to encourage consumer behavior with the on time payment of their bills, through the provision of a rewards program for making payments to participating payment receivers. The rewards are redeemable through third parties.

2. Prior Art

Rewards programs for consumers have been offered by airlines for many years. Such programs influence consumer behavior to remain loyal to an individual airline for their travel through the provision of rewards to customers who use the individual airline more frequently. In the case of airlines, the predominant award is miles, which much like points, may be traded for free travel and upgrades to normal travel.

Another modern rewards program is that offered by most supermarkets. Supermarkets and such vendors have been providing customers with store branded cards which bear information relating to the consumer and their account. Using the store card at each purchase entitles the consumer to purchase discounted goods, awards electronic coupons, and provides other rewards for the buyers purchases from the store issuing the card. Supermarket rewards programs are known to profit from selling the data concerning the customer's individual buying habits and demographic condition to third party vendors.

Also, in the recent past, credit card companies have initiated rewards programs for cardholders of the issuing bank. Cardholders using a particular bank's credit card can build up an inventory of useable points which are awarded for each purchase made with the credit card. The points in the user's account may be employed to buy or get discounts on future rewards. Subsequent to reaching an aggregate point total in their account, which exceeds an amount required for redemption for a prize, the consumer having the rewards account may choose a prize and have the points deducted from their total saved to pay for it or at least receive a substantial discount upon it.

While such rewards programs encourage the use of credit cards, by giving the user discounts and other rewards, and encourage purchases from vendors issuing a card, or through the use of a certain credit card, there is no system to encourage the payment of the cardholder's bills with the credit card company or with third parties tendering credit to buyers. The cardholder is thus rewarded for running up their bill with the issuer, or for spending more at a market and receiving more points. However, other than being encouraged to buy, consumers are not offered any reward program in any fashion to pay their bills, other than the natural leaning of a cardholder to avoid interest payments and penalties for late payment. Consequently, a large percentage of consumers with consumer credit accounts pay slowly, on the last day, or in many cases, late.

As such, there is an unmet need for an easily employed rewards system for consumers and for credit card holders, which will encourage users to pay their bills on time. Such a system should be employable to encourage the payment of vendors and service provider's bills, as well as the card issuer's billings to thereby help induce better financial behavior by the consumer and to provide a better cash flow with the credit provider or card issuing company. Such a system, in addition to encouraging on time payment of bills for the credit card itself, should be employable to encourage the on time payment of a buyer's bill using the credit card, to tender payments to vendors who are generally paid with cash, checks, or payments. For instance, utility companies could encourage on time payment of the customer's bill with the utility through the awarding of points to the consumer paying early or before a preset date. The utility would enable the plan through a credit card issuer. When the system detects an on time payment before a late date, points could be awarded to the consumer and tracked by the card issuer. To induce earlier payments, and thereby significantly increase cash flow and lower borrowing costs for the utility, extra points might be awarded for payments made a determined number of days before a due date.

If the utility or other vender is able to induce on time and even early payments from customers, the cost of money to the utility or vender would significantly reduce since less cash-flow borrowing would be necessary.

### SUMMARY OF THE INVENTION

The disclosed system provides a remedy to the noted shortcomings of conventional consumer spending reward plans, by providing inducement and encouragement to the consumer to timely pay their bills. Thus it provides inducement to consumers to responsible financial behavior using positive reinforcement of award points, virtual currency, coupons, and discounts, rather than penalties and interest and fees.

Further the disclosed system herein provides the ability of non-credit card issuing vendors and service providers, who normally have no means to induce responsible behavior, to do so though positive reinforcement. For instance, an electric or gas utility firm is enabled using the system herein with a means to encourage on time payment of customer's bills. This encouragement is enabled through the provision of rewards such as virtual currency, or points and/or coupons redeemable for prizes, to consumers who employ a particular credit card issued by a card company who has co-branded or otherwise made agreements with the vendor or service provider, to encourage and reward on time payments by their customers.

For utilities and local merchants who allow customers to pay on charge accounts, such a system would surely cause a surge in cash flow by providing a virtual currency aware, and/or points and/or other rewards to customers using the denoted credit card, to make a timely payment to the merchant or service provider. The increase in on time cash flow to a participating merchant or utility or other supplier, will as noted pay for itself through a reduction in operating costs by reducing the need to borrow funds for operations when cash flow is slowed.

For consumers who already subscribe to a rewards program through their employment of a specific credit from a particular card issuer, such a system of rewarding on time payments to vendors and service providers can be initiated using the card they have from a card issuer. This mode of the system would be a chance to increase their accumulation of point totals while encouraging good payment habits with their monthly bills. Further, it will encourage use of the particular card from the issuer thereby increasing revenues.

In cases where a rewards system exists with a card issuer, such consumers would be rewarded with virtual currency, or points or other renumeration, for each purchase they make with the credit card in a normal fashion. Virtual currency would be held in a virtual account and employable by the user to purchase from vendors and services providers subscribing to the system. Subsequently, through the tracking of payments by consumers for their monthly bills with vendors and service providers, who offer the reward for on time payment, the same consumer can be awarded virtual currency, and/or points for making their on time or early bill payment to those vendors or service providers.

In addition to rewarding on time payments by cardholders and consumers to stores and utilities and the like, the system could also reward early payments, or complete payments of a consumer's bill with the card issuer. In the case of early or on time payments to vendors or service providers, this would significantly increase and speed up the cash flow for the participating vendor. The cost savings of not having to carry the customer's credit should easily offset any costs for the vendor to the credit card issuer for the points being awarded a consumer for an on time payment. The resulting increase in cash flow as noted would lower borrowing costs and allow the vendor other cost saving moves which are available with increased cash flow such as taking discounts on their inventory purchases. The resulting savings of the vendors and utilities and the like from the on time payments could actually exceed any cost for the points they would pay to the credit card issuer which would be in charge of redeeming the points earned by the consumer for prizes. Large department store chains or gasoline companies who issue their own cards could offer the reward system in-house and thereby provide the consumer with products from that vendor such as free gasoline from a large oil company chain of gas stations.

The issuing credit card company would also benefit by being able to offer cardholders more incentive to use that issuer's card. Since a card issuer offering virtual currency and/or points and/or coupons or rewards, for both purchases and on time or early payments will have a more attractive rewards program for potential card users, they will surely see an increase in both users, and card use over time by cardholders. Card issuers without such a reward program for on time payment will of course lose customers to those offering such a program.

Consumers will of course reap the benefits of more competition from card issuers, as well as from the increased points for on time payment being added to their total or from just receiving on time points should they not have another rewards or points system with their issuer. Further, their budgeting habits will see a positive change since they will be induced to pay early or on time by the points rewards for reducing their balance and the resulting interest charges on a lower account balance.

Still further, the credit card issuers themselves could provide virtual currency, or points to cardholders for on time payment of their credit card bills, increasing the potential benefit to card holders for point accumulation and rewards. This would of course reduce costs for such companies from having to send dunning notices to their customers as well as allow for increased positive cash flow which would lower borrowing or capital costs.

With respect to the above description, before explaining at least one preferred embodiment of the method invention in detail, it is to be understood that the invention is not limited in its application to the details of operation nor the arrangement of the components or steps set forth in the following description or illustrations in the drawings. The various methods of implementation and operation of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other methods and systems for carrying out the several purposes of the present cardholder on time payment encouragement system. It is important, therefore, that the objects and claims be regarded as including such equivalent construction and methodology insofar as they do not depart from the spirit and scope of the present invention.

Further objectives of this invention will be brought out in the following part of the specification wherein detailed description is for the purpose of fully disclosing the invention without placing limitations thereon.

It is an object of this invention to provide a method to reward consumers who hold credit cards, inducement for responsible behavior through rewards for on time payments using such a credit card.

It is another object of this invention to provide such a reward system which will encourage consumers and customers of vendors and service providers, to pay their bill on time by awarding points which may be redeemed for gifts and discounts through a credit card issuer based on the timeliness of the payment rather than a purchase.

A further object of this invention is the provision of a virtual currency system for subscribing vendors and service providers to be paid for user's choosing virtual currency as an award.

Yet another object of the method herein is the provision of a reward system for consumers which will provide them with a reward program of cash or prizes which induces them to pay their bills, rather than run up their bills by spending more as current such rewards systems do.

Still further, it is an object of this invention to provide vendors, who may not be large enough to have their own rewards program, to join with a credit card issuer to encourage on time bill payment by their customers and thereby improve overall cash flow of the vendor by increasing on time payments of their credit customers.

These together with other objects and advantages which become subsequently apparent reside in the details of the construction and operation as more fully hereinafter described and claimed, reference being had to the accompanying drawings forming a part thereof, wherein like numerals refer to like parts throughout.

### BRIEF DESCRIPTION OF DRAWING FIGURES

FIG. 1 is a flow chart showing the on time reward system for consumers using their credit card to pay their bill with the issuer or a third party company on time.

### DETAILED DESCRIPTION OF THE PREFERRED EMBODIMENTS OF THE INVENTION

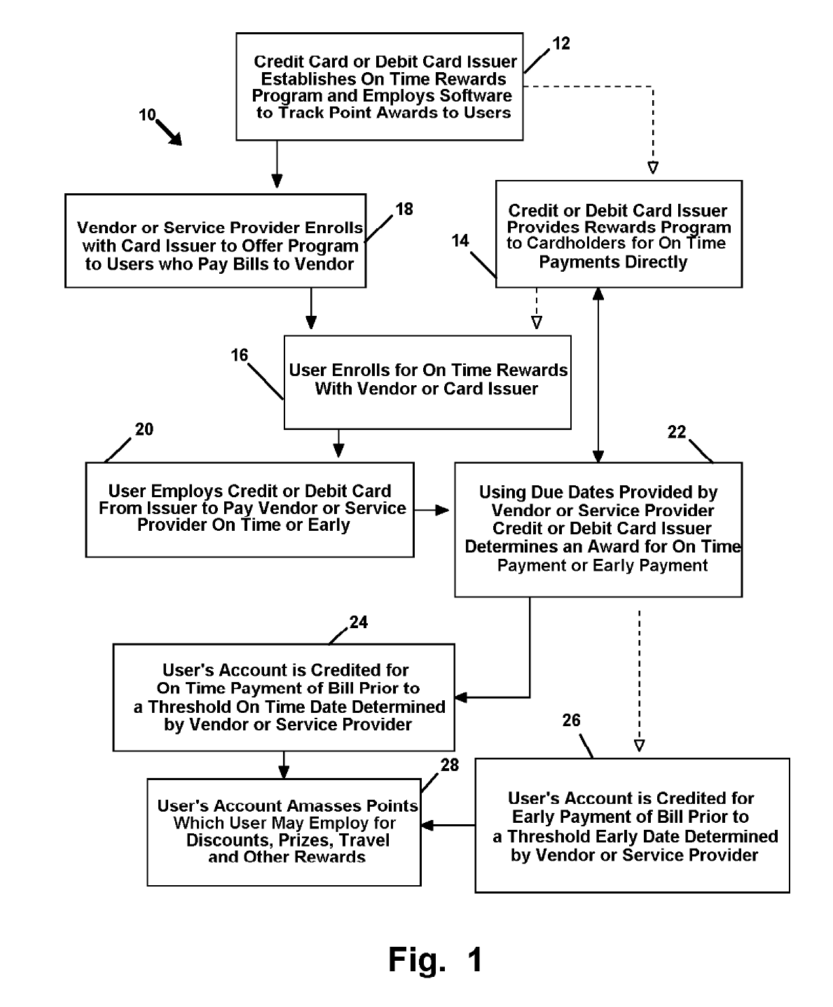

Referring now to the drawings in FIG. 1 wherein similar steps are identified by like reference numerals, there is seen in FIG. 1, the disclosed rewards system 10 to provide users with inducement to tender on time or early payments to vendors or service providers.

In the disclosed method herein in a first step 12, a credit card issuer such as a bank or department store, or a debit card issuer such as a bank, establishes an on time rewards program to reward user's on time or early payment of bills due. The card issuer may establish their own on time rewards program 14 as a supplement or other inducement program to cardholders. In this mode of the system, the card issuer would enroll 16 the user, and then provide the user with listings of vendors or service providers who have enrolled 18 with the card issuer to offer the on time payment program.

Alternatively, the vendor or service provider once enrolled 18, could advertise and offer the on time rewards program to users having accounts with the vendor or service provider.

The user, would thus enroll 16 with the vendor or service provider if they are offering the inducement program, or they may enroll with the card issuer if they are offering the inducement program. Or the user might enroll 16 with either of the card issuer or the vendor or service provider if such is arranged during vendor enrollment 18.

Once enrolled, when the user employs the issued credit or debit card to pay a vendor or service provider 20, software adapted to the task will ascertain the user is enrolled in the program and will communicate the payment to a server running software adapted to the system herein. Once the payment is communicated, the card issuer employing software adapted to the task, and using due dates provided by the respective vendor or service provider just paid by the user, will ascertain if the payment was on time 22 or alternatively early.

If the payment using the debit or credit card to the service provider 20 is determined on time, an account electronically tabulated for each user, is credited for the on time payment 24 of the bill prior to the threshold on time date provided by that vendor or service provider. Alternatively, the user's account can be credited for awards for early payments 26. Such payments would be made by the user before a threshold early date provided by the vendor or service provider. Or, in another mode of the system, users may be awarded virtual currency, which may be employed to buy products and services from subscribing vendors and service providers to the system.

All rewards in the form of one or a combination of rewards from a group consisting of award points, virtual currency, coupons and the like, may be amassed electronically in a user account 28 and stored until redeemed by the user. Redemption of the virtual currency, coupons, or reward points, may be employed by the user for any number of rewards, such as discounts, prizes from a catalog, travel, or other items or services for which the user can redeem amassed virtual currency, coupons. The rewards tendered my be to subscribing vendors of products and service providers or third party vendors of products and service providers if arranged in advance for such acceptance.

The system 10 herein can be employed in any country in the world where users pay vendors or service providers with credit or debit cards using any currency. Once customers are enrolled, they would endeavor to make on time, or early, payments to vendors or service providers who offer points, coupons, or virtual currency, for using the determined credit card or debit cards for payments in such a fashion. The system would track the amassed virtual currency, awards, and coupons, for each user, and provide electronic transfer of such to the participating vendors and service providers, from the user, when the user redeems them.

While all of the fundamental characteristics and features of the method for encouraging on time payments from consumers using rewards or points through credit card payments have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

Consequently, all such modifications and variations and substitutions are included within the scope of the invention as defined by the following claims.

What is claimed is:

1. A reward system, for encouraging on time, or early payment by users to vendors and service providers, comprising:
providing a computer interface over a network for vendors of products, and for service providers, to subscribe to the reward system;
providing a computer interface over a network for users to subscribe to the reward system;
providing input screens for said users to input data concerning accounts to which they issue payments;
ascertaining from said data concerning accounts, respective due dates for said payments by respective said users, to said vendors and said service providers;
tracking said payments by respective users and ascertaining when a respective said payment is tendered on or before said due date; and
awarding a reward to each said user for each said payment tendered on or before said due date.

2. The reward system of claim 1 additionally comprising:
maintaining electronic records of each said reward to each respective said user in a total aggregate reward; and
allowing each respective said user to access said electronic records and to direct all or a portion of said total aggregate reward as payment toward a purchase from said vendors for said products or said service providers.

3. The reward system of claim 1 additionally comprising:
awarding said reward as a discount coupon, said discount coupon tenderable to one or a plurality of said vendors for said products or said service providers.

4. The reward system of claim 2 additionally comprising:
awarding said reward as a discount coupon, said discount coupon tenderable to one or a plurality of said vendors for said products or said service providers.

5. The reward system of claim 1 additionally comprising:
awarding said reward as a discount coupon, said discount coupon tenderable by said user toward a purchase of products or services.

6. The reward system of claim 2 additionally comprising:
awarding said reward as a discount coupon, said discount coupon tenderable by said user toward a purchase of products or services.

7. The reward system of claim 1 additionally comprising:
awarding said reward as virtual currency, said virtual currency tenderable to one or a plurality of said vendors for said products or said service providers.

8. The reward system of claim 2 additionally comprising:
awarding said reward as virtual currency, said virtual currency tenderable to one or a plurality of said vendors for said products or said service providers.

9. The reward system of claim 3 additionally comprising:
awarding said reward as virtual currency, said virtual currency tenderable to one or a plurality of said vendors for said products or said service providers.

10. The reward system of claim 4 additionally comprising:
awarding said reward as virtual currency, said virtual currency tenderable to one or a plurality of said vendors for said products or said service providers.

11. The reward system of claim 1 additionally comprising:
allowing said vendors for said products and said service providers to define an early payment date prior to said due date;
tracking said payments by respective users and ascertaining when a respective said payment is tendered on or before said early payment date; and
awarding a second reward to each said user for each said payment tendered on or before said early payment date.

12. The reward system of claim 2 additionally comprising:
allowing said vendors for said products and said service providers to define an early payment date prior to said due date;
tracking said payments by respective users and ascertaining when a respective said payment is tendered on or before said early payment date; and
awarding a second reward to each said user for each said payment tendered on or before said early payment date.

13. The reward system of claim 3 additionally comprising:
allowing said vendors for said products and said service providers to define an early payment date prior to said due date;
tracking said payments by respective users and ascertaining when a respective said payment is tendered on or before said early payment date; and
awarding a second reward to each said user for each said payment tendered on or before said early payment date;
tendering said second reward to said user as one or a combination of a group of rewards consisting of, discount coupons, points, or virtual currency, all of which being tenderable to said venders for said products or said service providers as payment.

14. The reward system of claim 4 additionally comprising:
allowing said vendors for said products and said service providers to define an early payment date prior to said due date;
tracking said payments by respective users and ascertaining when a respective said payment is tendered on or before said early payment date; and
awarding a second reward to each said user for each said payment tendered on or before said early payment date;
tendering said second reward to said user as one or a combination of a group of rewards consisting of, discount coupons, points, or virtual currency, all of which being tenderable to said vendors for said products or said service providers as payment.

15. The reward system of claim 1 additionally comprising:
awarding said reward as points, said points tenderable as payment to one or a plurality of said vendors for said products or said service providers.

16. The reward system of claim 2 additionally comprising:
awarding said reward as points, said points tenderable to one or a plurality of said vendors for said products or said service providers.
